(19) United States
(12) Patent Application Publication
(10) Pub. No.: US 2024/0222640 A1
(43) Pub. Date: Jul. 4, 2024

(54) COPPER FOIL, ELECTRODE COMPRISING THE SAME, SECONDARY BATTERY COMPRISING THE SAME, AND METHOD FOR MANUFACTURING THE SAME

(71) Applicant: SK NEXILIS CO., LTD., Jeongeup-si Jeollabuk-do (KR)

(72) Inventors: Shan Hua JIN, Jeongeup-si Jeollabuk-do (KR); Min Seok YOON, Jeongeup-si Jeollabuk-do (KR)

(21) Appl. No.: 18/392,669

(22) Filed: Dec. 21, 2023

(30) Foreign Application Priority Data
Dec. 28, 2022 (KR) 10-2022-0187296
Oct. 5, 2023 (KR) 10-2023-0132913

(51) Int. Cl. H01M 4/66; H01M 4/70

(52) U.S. Cl. CPC H01M 4/661; H01M 4/667; H01M 4/70; H01M 2004/027

(57) ABSTRACT

According to one embodiment of the present disclosure, there is provided a copper foil including a copper film including 99.9 wt % or more of copper, wherein the copper foil has a first weight retention rate of 0.1% or less, and a second weight retention rate of 0.3% or less.

### CROSS-REFERENCE TO RELATED APPLICATIONS

This application claims the benefit of the Korean Patent Application No. 10-2022-0187296 filed on Dec. 28, 2022 and Korean Patent Application No. 10-2023-0132913 filed on Oct. 5, 2023, which are hereby incorporated by reference as if fully set forth herein.

### FIELD

The present disclosure relates to a copper foil, an electrode including the same, a secondary battery including the same, and a method for manufacturing the same.

### BACKGROUND

Secondary batteries are types of energy conversion devices that convert electrical energy into chemical energy, store the chemical energy therein, and then convert the chemical energy back to electrical energy when electricity is needed, thereby generating electricity. The secondary batteries are used as energy sources for electric vehicles as well as portable home appliances such as mobile phones, laptop computers, and the like. The secondary batteries are rechargeable and thus are also referred to as rechargeable batteries.

As secondary batteries that have economic and environmental advantages over disposable primary batteries, there are lead-acid batteries, nickel-cadmium secondary batteries, nickel-hydrogen secondary batteries, and lithium secondary batteries.

In particular, lithium secondary batteries may store a relatively large amount of energy relative to their size and weight compared with other secondary batteries. Accordingly, in the field of information communication devices in which portability and mobility are important, the lithium secondary batteries are preferred, and an application range thereof is also expanding to energy storage devices for hybrid vehicles and electric vehicles.

Lithium secondary batteries are repeatedly used through one cycle of charging and discharging. When a certain device is operated with a fully charged lithium secondary battery, the lithium secondary battery should have a high charge/discharge capacity in order to increase the operating time of the device. Accordingly, research to satisfy ever-increasing expectations (needs) of consumers regarding the charge/discharge capacity of a lithium secondary battery is continuously required.

Such a secondary battery includes an anode current collector made of a copper foil, and among copper foils, an electrolytic copper foil is widely used as an anode current collector of a secondary battery. Along with an increase in demand for secondary batteries, there is an increase in demand for secondary batteries with high capacity, high efficiency, and high quality, and thus, there is a need for electrolytic copper foils capable of improving characteristics of secondary batteries. In particular, there is a need for electrolytic copper foils that can ensure high capacity to secondary batteries and enable secondary batteries to stably maintain capacity and performance.

Meanwhile, when a copper foil is used as an anode current collector for a secondary battery, the surface of the copper foil may be easily dissolved by an external environment. Accordingly, research is continuously being conducted to ensure that a surface state of the copper foil is not easily changed by an external environment.

### SUMMARY

Accordingly, the present disclosure relates to a copper foil capable of preventing the problems caused by the limitations and disadvantages of the related art described above, an electrode including the same, a secondary battery including the same, and a method for manufacturing the same.

According to one embodiment of the present disclosure, there is provided a copper foil having a first weight retention rate of 0.1% or less so that a surface state thereof is maintained and wrinkles or tears thereof are prevented, even after immersion.

According to another embodiment of the present disclosure, there is provided a copper foil having a second weight retention rate of 0.3% or less so that a surface state thereof is maintained and wrinkles or tears thereof are prevented, even after immersion.

According to still another embodiment of the present disclosure, there is provided a copper foil having a first roughness variation of 0.7 μm or less so that a surface state thereof is maintained and wrinkles or tears thereof are prevented, even after immersion.

According to yet another embodiment of the present disclosure, there is provided a copper foil having a second roughness variation of 0.8 μm or less so that a surface state thereof is maintained and wrinkles or tears thereof are prevented, even after immersion.

According to yet another embodiment of the present disclosure, there is provided an electrode for a secondary battery including the copper foil, and a secondary battery including the electrode for a secondary battery.

According to yet another embodiment of the present disclosure, there is provided a method for manufacturing a copper foil in which the occurrence of curls, wrinkles, or tears is prevented.

In addition to the aspects of the present disclosure described above, other features and advantages of the present disclosure will be described in the following detailed description, or may be clearly understood by those skilled in the art to which the present disclosure pertains from such description.

According to one embodiment of the present disclosure, there is provided a copper foil including a copper film including 99.9 wt % or more of copper, wherein the copper foil has a first weight retention rate of 0.1% or less, and a second weight retention rate of 0.3% or less. The first weight retention rate is calculated by Equation 1 below,

first weight retention rate=|(weight after5 hr immersion-weight before immersion)/weight before immersion*100|. The second weight retention rate is calculated by Equation2below, [Equation 1]

second weight retention rate=|(weight after24hr immersion-weight before immersion)/weight before immersion*100|. [Equation 2]

According to another embodiment of the present disclosure, there is provided an electrode for a secondary battery, the electrode including a copper foil and an active material layer disposed on at least one surface of the copper foil.

According to still another embodiment of the present disclosure, there is provided a secondary battery including a cathode configured to provide lithium ions during charging, and anode configured to provide electrons and lithium ions during discharge, an electrolyte disposed between the cathode and the anode to provide an environment in which the lithium ions are movable, and a separator configured to electrically insulate the anode and the cathode.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a cross-sectional view of a copper foil according to one embodiment of the present disclosure:

FIG. 2 is a cross-sectional view of a copper foil according to another embodiment of the present disclosure:

FIG. 3 is a cross-sectional view of an electrode for a secondary battery according to still another embodiment of the present disclosure;

FIG. 4 is a cross-sectional view of an electrode for a secondary battery according to yet another embodiment of the present disclosure:

FIG. 5 is a schematic cross-sectional view of a secondary battery according to yet another embodiment of the present disclosure: and

FIG. 6 is a device for manufacturing a copper foil according to yet another embodiment of the present disclosure.

### DETAILED DESCRIPTION

Hereinafter, embodiments of the present disclosure will be described in detail with reference to the accompanying drawings. However, the embodiments described below are presented only for illustrative purposes to facilitate a clear understanding of the present disclosure and do not limit the scope of the present disclosure.

Shapes, sizes, ratios, angles, numbers, and the like disclosed in the drawings for describing the embodiments of the present disclosure are illustrative, and thus the present disclosure is not limited to the details illustrated in the drawings. Throughout the present specification, the same components may be referred to by the same reference numerals. In describing the present disclosure, detailed descriptions of related known technologies will be omitted when it is determined that they may unnecessarily obscure the gist of the present disclosure.

When terms “including,” “having,” “consisting of,” and the like described in the present specification are used, other parts may be added unless the term “only” is used herein. When a component is expressed in the singular form, the plural form is included unless otherwise specified. In addition, in interpreting a component, it is interpreted as including an error range even when not explicitly stated.

In describing a positional relationship, for example, when a positional relationship of two parts is described as being “on,” “above,” “below, “next to,” or the like, unless “immediately” or “directly” is used, one or more other parts may be located between the two parts.

Spatially relative terms, such as “below,” “beneath,” “lower,” “above,” “upper” and the like, may be used herein for ease of description to describe one element or component's relationship to another element(s) or component(s) as illustrated in the drawings. It will be understood that the spatially relative terms are intended to include different orientations of the element in use or operation in addition to the orientation illustrated in the drawings. For example, when an element in the drawings is turned over, an element described as being “above” or “upper” relative to another element will then be “below” or “lower” relative to the other element. Thus, the exemplary term “below” may include both above and below orientations. Likewise, the exemplary terms “above” or “upper” may include both above and below orientations.

In describing a temporal relationship, for example, when a temporal relationship is described as being “after,” “subsequent,” “next to,” “prior to,” or the like, unless “immediately” or “directly” is used, cases that are not continuous may also be included.

In order to describe various components, terms such as “first,” “second,” and the like are used, but these components are not limited by these terms. These terms are only used to distinguish one component from another component. Therefore, a first component described below may be a second component within the technical spirit of the present disclosure.

The term “at least one” should be understood to include all possible combinations from one or more related items. For example, the meaning of “at least one of first, second, and third items” may mean all combinations of two or more items of the first, second and third items as well as each of the first, second and third items.

The features of various embodiments of the present disclosure may be partially or wholly coupled to or combined with each other, and may be various technically linked or operated, and each of the embodiments may be implemented independently of each other or may be implemented together in a related relationship.

FIG. 1 is a cross-sectional view of a copper foil 110 according to one embodiment of the present disclosure.

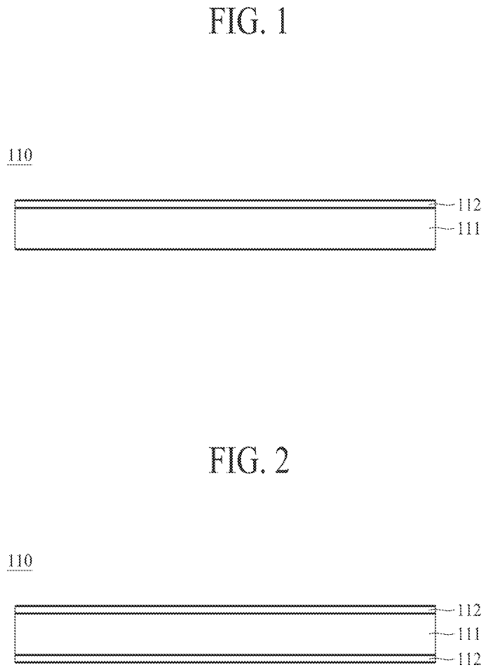

Referring to FIG. 1, the copper foil 110 of the present disclosure includes a copper film 111 including 99.9 wt % or more of copper and a protective layer 112 formed on the copper film 111. In the copper foil 110 illustrated in FIG. 1, the protective layer 112 is formed on one surface of the copper film 111, but the embodiments of the present disclosure are not limited thereto. Referring to FIG. 2, the protective layer 112 may be formed on each of both surfaces of the copper film 111.

The copper film 111 may be formed on a rotating anode drum through electroplating, and may have a shiny surface that is in direct contact with the rotating anode drum in the electroplating process and a matte surface opposite to the shiny surface.

The protective layer 112 is formed by electrodepositing an anticorrosion material on the copper film 111. The anticorrosion material may include at least one of a chromium compound, a silane compound, and a nitrogen compound. The protective layer 112 prevents oxidation and corrosion of the copper film 111 and improves heat resistance, thereby increasing a lifespan of a final product including the copper foil 110 as well as a lifespan of the copper foil 110 itself.

According to one embodiment of the present disclosure, the copper foil 110 has a first weight retention rate of 0.1% or less. The first weight retention rate may be obtained through a calculation according to Equation 1 below.

First weight retention rate=|(weight after5hr immersion-weight before immersion)/weight before immersion*100| [Equation 1]

The weight after 5 hr immersion in Equation 1 refers to a weight of a sample measured after immersing the sample in a 20% NaOH solution for 5 hours.

The weight before immersion in Equation 1 refers to a weight of the sample measured before immersing the sample in the 20% NaOH solution.

When the first weight retention rate of the copper foil 110 exceeds 0.1%, after the immersion for 5 hours, changes in both weight and surface state of the copper foil 110 may be increased. As a result, the copper foil 110 may not have excellent coatability on an active material, and adhesive strength between the copper foil 110 and an active material layer may be reduced. In addition, when the change in surface state of the copper foil 110 is increased, wrinkles or tears may occur.

Accordingly, in order to prevent the occurrence of wrinkles or tears in the manufacturing process of the copper foil while maintaining the surface state even after immersion so that the occurrence of wrinkles or tears is prevented, it is necessary for the first weight retention rate of the copper foil 110 to be 0.1% or less.

According to one embodiment of the present disclosure, the copper foil 110 has a second weight retention rate of 0.3% or less. The second weight retention rate may be obtained through a calculation according to Equation 2 below.

Second weight retention rate=|(weight after24hr immersion-weight before immersion)/weight before immersion*100| [Equation 2]

The weight after 24 hr immersion in Equation 2 refers to a weight of a sample measured after immersing the sample in a 20% NaOH solution for 24 hours.

The weight before immersion in Equation 2 refers to a weight of the sample measured before immersing the sample in the 20% NaOH solution.

When the second weight retention rate of the copper foil 110 exceeds 0.3%, after the immersion for 24 hours, changes in both weight and surface state of the copper foil 110 may be increased. As a result, the copper foil 110 may not have excellent coatability on an active material, and the adhesive strength between the copper foil 110 and the active material layer may be reduced. In addition, when the change in surface state of the copper foil 110 is increased, wrinkles or tears may occur.

Accordingly, in order to prevent the occurrence of wrinkles or tears in the manufacturing process of the copper foil while maintaining the surface state even after immersion so that the occurrence of wrinkles or tears is prevented, it is necessary for the second weight retention rate of the copper foil 110 to be 0.3% or less.

According to one embodiment of the present disclosure, the copper foil 110 has a first roughness variation of 0.7 μm or less. The copper foil 110 may have a matte surface (M surface) and a shiny surface (S surface). According to one embodiment of the present disclosure, the copper film 111 may be formed on a rotating anode drum 40 through electroplating, and has a surface (the shiny surface) coming into contact with the rotating anode drum 40 and a surface (the matte surface) opposite to the shiny surface.

The first roughness variation may be obtained through a calculation according to Equation 3 below.

First roughness variation=|surface roughness(Rz) of matte surface after24hr immersion-surface roughness(Rz) of matte surface before immersion [Equation 3]

The surface roughness (Rz) of the matte surface after 24 hr immersion in Equation 3 refers to a ten-point average roughness (Rz) of the matte surface (M surface) of the copper foil 110 after immersing the copper foil 110 in a 20% NaOH solution for 24 hours.

The surface roughness (Rz) of the matte surface before the immersion in Equation 3 refers to a ten-point average roughness (Rz) of the matte surface (M surface) of the copper foil 110 before the immersion.

When the first roughness variation of the copper foil 110 exceeds 0.7 μm, the change in surface state of the copper foil 110 may be increased after the immersion for 24 hours. As a result, the copper foil 110 may not have excellent coatability on an active material, and adhesive strength between the copper foil 110 and the active material layer may be reduced. In addition, when the change in surface state of the copper foil 110 is increased, wrinkles or tears may occur.

Accordingly, in order to maintain the surface state of the copper foil 110 to prevent the occurrence of wrinkles or tears, it is necessary for the first roughness variation of the copper foil 110 to be 0.7 μm or less.

According to one embodiment of the present disclosure, the copper foil 110 has a second roughness variation of 0.8 μm or less.

The second roughness variation may be obtained through a calculation according to Equation 4 below.

Second roughness variation=|surface roughness(Rz) of shiny surface after24hr immersion-surface roughness(Rz) of shiny surface before immersion| [Equation 4]

The surface roughness (Rz) of the shiny surface after 24 hr immersion in Equation 4 refers to a ten-point average roughness (Rz) of the shiny surface (S surface) of the copper foil 110 after immersing the copper foil 110 in a 20% NaOH solution for 24 hours.

The surface roughness (Rz) of the shiny surface before the immersion in Equation 4 refers to a ten-point average roughness (Rz) of the shiny surface (S surface) of the copper foil 110 before the immersion.

When the second roughness variation of the copper foil 110 exceeds 0.8 μm, the change in surface state of the copper foil 110 may be increased after the immersion for 24 hours. As a result, the copper foil 110 may not have excellent coatability on an active material, and an adhesive strength between the copper foil 110 and the active material layer may be reduced. In addition, when the change in surface state of the copper foil 110 is increased, wrinkles or tears may occur.

Accordingly, in order to maintain the surface state of the copper foil 110 to prevent the occurrence of wrinkles or tears, it is necessary for the second roughness variation of the copper foil 110 to be 0.8 μm or less.

The copper foil 110 according to one embodiment of the present disclosure has a thickness of 4 μm to 35 μm. When the copper foil 110 is used as a current collector of an electrode in a secondary battery, as the thickness of the copper foil 110 becomes smaller, more current collectors can be accommodated in the same space, which is advantageous for high capacity of the secondary battery. However, the manufacture of a copper foil 110 having a thickness of less than 4 μm causes a decrease in workability.

On the other hand, when the secondary battery is manufactured with the copper foil 110 with a thickness exceeding 35 μm, it becomes difficult to achieve high capacity due to the thick copper foil 110.

Hereinafter, an electrode 100 including the copper foil 110 of the present disclosure and a secondary battery including the electrode 100 will be described in detail.

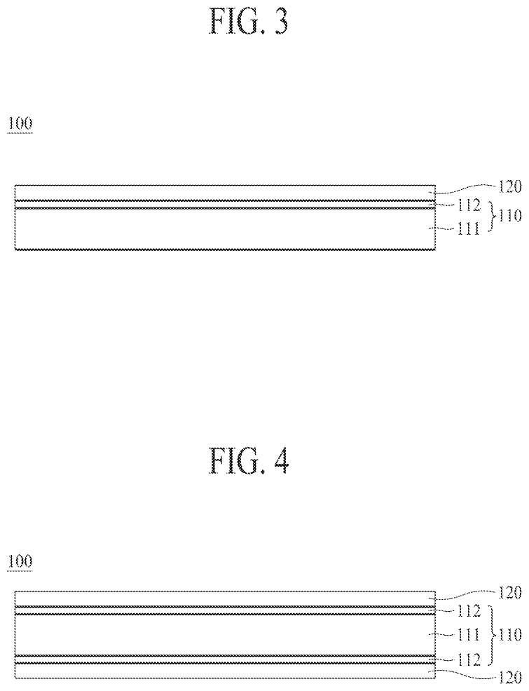

FIG. 3 is a cross-sectional view of an electrode for a secondary battery according to one embodiment of the present disclosure.

As illustrated in FIG. 3, the electrode 100 for a secondary battery according to one embodiment of the present disclosure includes the copper foil 110 of one of the above-described embodiments of the present disclosure and an active material layer 120.

FIG. 3 illustrates a configuration in which the active material layer 120 is formed on one surface of the copper foil 110. However, the present disclosure is not limited thereto, and referring to FIG. 4, the active material layer 120 may be formed on each of both surfaces of the copper foil 110.

Generally, in a lithium secondary battery, an aluminum foil is used as a cathode current collector combined with a cathode active material, and the copper foil 110 is used as an anode current collector combined with an anode active material.

According to one embodiment of the present disclosure, the electrode 100 for a secondary battery is an anode, the copper foil 110 is used as an anode current collector, and the active material layer 120 includes an anode active material.

In order to secure a high capacity of a secondary battery, the active material layer 120 of the present disclosure may be formed of a composite of carbon and metal. The metal may include, for example, at least one of silicon (Si), germanium (Ge), tin (Sn), lithium (Li), zinc (Zn), magnesium (Mg), cadmium (Cd), cerium (Ce), nickel (Ni), and iron (Fe), and preferably, may include Si and/or Sn.

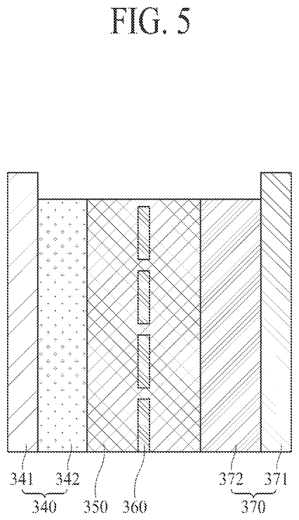

FIG. 5 is a schematic cross-sectional view of a secondary battery according to one embodiment of the present disclosure.

Referring to FIG. 5, the secondary battery includes a cathode 370, an anode 340, an electrolyte 350 disposed between the cathode 370 and the anode 340 to provide an environment in which ions can move, and a separator 360 electrically insulating the cathode 370 and the anode 340. Here, the ions moving between the cathode 370 and the anode 340 are, for example, lithium ions. The separator 360 separates the cathode 370 and the anode 340 in order to prevent charges generated at one electrode from being needlessly consumed by moving to another electrode through the inside of the secondary battery. Referring to FIG. 5, the separator 360 is disposed in the electrolyte 350.

The cathode 370 includes a cathode current collector 371 and a cathode active material layer 372, and an aluminum foil may be used as the cathode current collector 371.

The anode 340 includes an anode current collector 341 and an anode active material layer 342, and the copper foil 110 may be used as the anode current collector 341.

According to one embodiment of the present disclosure, the copper foil 110 disclosed in FIG. 1 or 2 may be used as the anode current collector 341. In addition, the electrode 100 for a secondary battery illustrated in FIG. 3 or 4 may be used as the anode 340 of the secondary battery illustrated in FIG. 5.

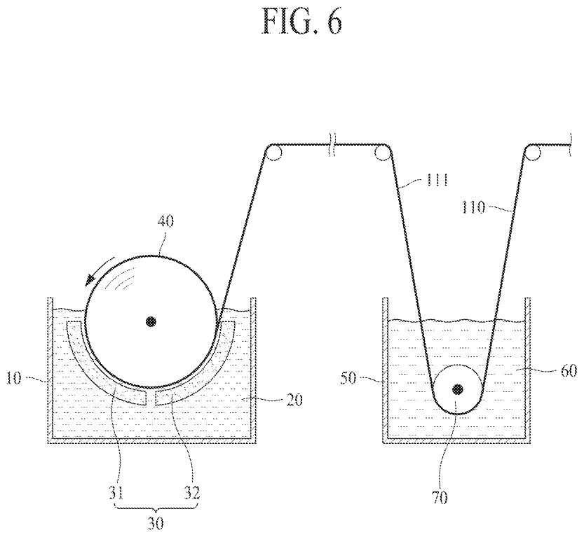

Hereinafter, a method for manufacturing the copper foil 110 of the present disclosure will be described in detail with reference to FIG. 6.

The method for manufacturing the copper foil 110 of the present disclosure includes forming a copper film 111, and forming a protective layer 112 on the copper film 111.

The method of the present disclosure includes forming the copper film 111 on a rotating anode drum 40 by electrically connecting a cathode plate 30 and the rotating anode drum 40, which are disposed to be spaced apart from each other in an electrolyte 20 in an electrolytic bath 10.

As illustrated in FIG. 6, the cathode plate 30 may include first and second cathode plates 31 and 32 electrically insulated from each other.

The forming of the copper film 111 may be performed by forming a seed layer through an electrical connection between the first cathode plate 31 and the rotating anode drum 40, and then growing a seed layer through an electrical connection between the second cathode plate 32 and the rotating anode drum 40.

A current density provided by each of the first and second cathode plates 31 and 32 may be 30 to 130 ASD (A/dm²).

When the current density provided by each of the first and second cathode plates 31 and 32 is less than 30 ASD, a surface roughness of the copper foil 110 is reduced, and thus an adhesion between the copper foil 110 and the active material layer 120 may not be sufficient.

On the other hand, when the current density provided by each of the first and second cathode plates 31 and 32 exceeds 130 ASD, a surface of the copper foil 110 may be rough, and thus the active material may not be smoothly coated.

The surface characteristics of the copper film 111 may be changed according to a buffing or polishing degree of a surface of the rotating anode drum 40. For example, the surface of the rotating anode drum 40 may be polished using a polishing brush having a grit of #800 to #3000.

In the process of forming the copper film 111, the electrolyte 20 is maintained at a temperature of 48° C. to 60° C. More specifically, the temperature of the electrolyte 20 may be maintained at 50° C. or higher. At this time, the physical, chemical, and electrical characteristics of the copper film 111 may be controlled by adjusting a composition of the electrolyte 20.

According to one embodiment of the present disclosure, the electrolyte 20 includes copper ions at a concentration of 70 g/L to 100 g/L, sulfuric acid at a concentration of 70 g/L to 150 g/L, chlorine (Cl) at a concentration of 15 ppm to 25 ppm, lead ions (Pb²⁺) at a concentration of 1 ppm to 100 ppm, arsenic (As) at a concentration of 0.5 ppm to 5 ppm, silver ions (Ag⁺) at a concentration of 0.1 ppm to 3 ppm, hydrogen peroxide (H₂O₂) at a concentration of 1 ml/L to 10 ml/L, and an organic additive.

In order to facilitate the formation of the copper film 111 through copper electrodeposition, the concentration of the copper ions and the concentration of the sulfuric acid in the electrolyte 20 are adjusted in a range of 70 g/L to 100 g/L and a range of 70 g/L to 150 g/L, respectively.

In one embodiment of the present disclosure, the chlorine (Cl) includes all of chlorine ions (Cl—) and chlorine atoms present in a molecule. The chlorine (CI) may, for example, be used to remove silver (Ag) ions input into the electrolyte 20 in a process of forming the copper film 111. Specifically, the chlorine (Cl) may precipitate silver (Ag) ions in the form of silver chloride (AgCl). The silver chloride (AgCl) may be removed through filtration.

When the concentration of the chlorine (Cl) is less than 15 ppm, the silver (Ag) ions are not removed well. On the other hand, when the concentration of the chlorine (CI) exceeds 25 ppm, unnecessary reaction may occur due to the excessive amount of the chlorine (CI). Accordingly, the concentration of the chlorine (CI) in the electrolyte 20 is controlled in a range of 15 ppm to 25 ppm.

According to one embodiment of the present disclosure, the electrolyte 20 including an organic additive may further include lead ions (Pb²⁺). Specifically, the electrolyte 20 may include lead ions (Pb²⁺) at a concentration of 1 ppm to 100 ppm. When the lead ions (Pb²⁺) are maintained at the concentration of 1 ppm to 100 ppm, the first weight retention rate according to the present disclosure may be maintained at 0.1% or less, and the second weight retention rate may be maintained at 0.3% or less. In addition, the first roughness variation may be maintained at 0.7 μm or less, and the second roughness variation may be maintained at 0.8 μm or less.

On the other hand, when the concentration of the lead ions (Pb²⁺) is less than 1 ppm, a problem may occur where effectiveness is reduced in terms of maintaining the physical properties of the present disclosure. Accordingly, there is a rapid change in the weight of the copper foil 110 after the immersion, causing the first weight retention rate to exceed 0.1% and the second weight retention rate to exceed 0.3%. In addition, the surface of the copper foil 110 may be non-uniform, causing the first roughness variation to exceed 0.7 μm and the second roughness variation to exceed 0.8 μm.

In addition, when the concentration of the lead ions (Pb²⁺) exceeds 100 ppm, copper is non-uniformly precipitated, and thus, there is a rapid change in the weight of the copper foil 110 after the immersion, causing the first weight retention rate to exceed 0.1% and the second weight retention rate to exceed 0.3%. In addition, the surface of the copper foil 110 may be non-uniform, causing the first roughness variation to exceed 0.7 μm and the second roughness variation to exceed 0.8 μm.

According to one embodiment of the present disclosure, the electrolyte 20 including an organic additive may further include arsenic (As). Specifically, the electrolyte 20 may include the arsenic (As) at a concentration of 0.5 ppm to 5 ppm. When the arsenic (As) is maintained at the concentration of 0.5 ppm to 5 ppm, the first weight retention rate according to the present disclosure may be maintained at 0.1% or less, and the second weight retention rate may be maintained at 0.3% or less. In addition, the arsenic (As) serves as an accelerator for accelerating a reduction reaction of copper (Cu) in a certain concentration section. However, in the electrolyte 20, the arsenic (As) may be present, for example, in a trivalent or pentavalent ionic state (As³⁺ or As⁵⁺).

On the other hand, when the concentration of the arsenic (As) is less than 0.5 ppm, the reduction reaction of copper is reduced, and thus, there is a rapid change in the weight of the copper foil 110 after the immersion, causing the first weight retention rate to exceed 0.1% and the second weight retention rate to exceed 0.3%. In addition, due to the reduction of the reduction reaction of copper, the surface of the copper foil 110 becomes irregular, causing the first roughness variation to exceed 0.7 μm and the second roughness variation to exceed 0.8 μm.

In addition, when the concentration of the arsenic (As) exceeds 5 ppm, the reduction reaction of copper occurs excessively, and thus, there is a rapid change in the weight of the copper foil 110 after the immersion, causing the first weight retention rate to exceed 0.1% and the second weight retention rate to exceed 0.3%. In addition, due to the excessive reduction reaction of copper, the surface of the copper foil 110 becomes irregular, causing the first roughness variation to exceed 0.7 μm and the second roughness variation to exceed 0.8 μm.

In addition, according to one embodiment of the present disclosure, the electrolyte 20 including an organic additive may further include silver (Ag). Specifically, the electrolyte 20 may include the silver (Ag) at a concentration of 0.1 ppm to 3 ppm. When the silver (Ag) is maintained at the concentration of 0.1 to 3 ppm, the first weight retention rate according to the present disclosure may be maintained at 0.1% or less, and the second weight retention rate may be maintained at 0.3% or less.

On the other hand, when the concentration of the silver (Ag) is less than 0.1 ppm, the first weight retention rate may exceed 0.1%, and the second weight retention rate may exceed 0.3%.

In addition, when the concentration of the silver (Ag) exceeds 3 ppm, copper is non-uniformly electrodeposited on the rotating anode drum. Accordingly, there is a rapid change in the weight of the copper foil 110 after the immersion, causing the first weight retention rate to exceed 0.1% and the second weight retention rate to exceed 0.3%. In addition, due to the non-uniform electrodeposition of copper, the surface of the copper foil 110 becomes irregular, causing the first roughness variation to exceed 0.7 μm and the second roughness variation to exceed 0.8 μm.

According to one embodiment of the present disclosure, the electrolyte 20 including an organic additive may further include hydrogen peroxide (H₂O₂). Due to the organic additive, organic impurities may be present in the electrolyte 20 that is continuously plated, and a content of carbon (C) in the copper foil may be appropriately adjusted by decomposing the organic impurities by treating the organic impurities with hydrogen peroxide (H₂O₂). As a concentration of total organic carbon (TOC) in the electrolyte 20 is increased, an amount of carbon (C) elements input into the copper film 111 is increased, and thus a total amount of elements detached from the copper film 111 during heat treatment is increased, which causes a change in the surface state of the copper foil 110, resulting in changes in both the weight and the surface roughness of the copper foil 110 after immersion.

The hydrogen peroxide (H₂O₂) is added in an amount of 1 ml to 10 ml per one L of the electrolyte. Specifically, the hydrogen peroxide (H₂O₂) may be added in an amount of 2 ml to 8 ml per one L of the electrolyte. When the amount of the added hydrogen peroxide (H₂O₂) is less than 1 ml/L, it is meaningless because there is little effect on the decomposition of organic impurities. When the amount of the added hydrogen peroxide (H₂O₂) exceeds 10 ml/L, the organic impurities are excessively decomposed, and thus, the effects of organic additives such as a polishing agent, a moderator, and a roughness regulator, are also suppressed.

The organic additive included in the electrolyte 20 includes at least one of a polishing agent (component A), a moderator (component B), and a roughness regulator (component C). The organic additive in the electrolyte 20 has a concentration of 1 ppm to 100 ppm.

The organic additive may include two or more of the polishing agent (component A), the moderator (component B), and the roughness regulator (component C), and may include all of the three components. Even in this case, the concentration of the organic additive is 100 ppm or less. When the organic additive includes all of the polishing agent (component A), the moderator (component B), and the roughness regulator (component C), the organic additive may have a concentration of 10 ppm to 100 ppm.

The polishing agent (component A) includes sulfonic acid or a metal salt thereof. The polishing agent (component A) may have a concentration of 1 ppm to 15 ppm in the electrolyte 20.

The polishing agent (component A) may increase an amount of electric charges of the electrolyte 20 to improve an electrodeposition speed of copper, may improve the curling characteristics of the copper foil, and may increase the gloss of the copper foil 110. When the concentration of the polishing agent (component A) is less than 1 ppm, the gloss of the copper foil 110 is lowered, and when the concentration of the polishing agent (component A) exceeds 15 ppm, the weight and the surface roughness of the copper foil 110 after immersion may be changed. Accordingly, there is a rapid change in the weight of the copper foil 110 after the immersion, causing the first weight retention rate to exceed 0.1% and the second weight retention rate to exceed 0.3%. In addition, copper is non-uniformly electrodeposited, and thus, the surface of the copper foil 110 becomes irregular, causing the first roughness variation to exceed 0.7 μm and the second roughness variation to exceed 0.8 μm.

More specifically, the polishing agent (component A) may have a concentration of 5 ppm to 10 ppm in the electrolyte 20.

The polishing agent may include, for example, at least one selected from among a bis-(3-sulfopropyl)-disulfide disodium salt, 3-mercapto-1-propanesulfonic acid, a 3-(N,N-dimethylthiocarbamoyl)-thiopropanesulfonate sodium salt, a 3-[(amino-iminomethyl)thio]-1-propanesulfonate sodium salt, an O-ethyldithiocarbonato-S-(3-sulfopropyl)-ester sodium salt, a 3-(benzothiazolyl-2-mercapto)-propyl-sulfonic acid sodium salt, and an ethylenedithiodipropylsulfonic acid sodium salt.

The moderator (component B) includes a non-ionic water-soluble polymer. The moderator (component B) may have a concentration of 1 ppm to 15 ppm in the electrolyte 20.

The moderator (component B) reduces the electrodeposition speed of copper to prevent an rapid increase in roughness and a decrease in strength of the copper foil 110. This moderator (component B) is referred to as an inhibitor or suppressor.

When the concentration of the moderator (component B) is less than 1 ppm, the weight and the surface roughness of the copper foil 110 after immersion may be changed. Accordingly, there is a rapid change in the weight of the copper foil 110 after the immersion, causing the first weight retention rate to exceed 0.1% and the second weight retention rate to exceed 0.3%. In addition, copper is non-uniformly electrodeposited, and thus, the surface of the copper foil 110 becomes irregular, causing the first roughness variation to exceed 0.7 μm and the second roughness variation to exceed 0.8 μm.

On the other hand, although the concentration of the moderator (component B) exceeds 15 ppm, there is almost no change in physical properties such as the appearance, gloss, roughness, strength, and elongation of the copper foil 110. Accordingly, without increasing manufacturing costs and wasting raw materials due to an unnecessary increase in concentration of the moderator (component B), the concentration of the moderator (component B) may be adjusted in a range of 1 ppm to 15 ppm.

The moderator (component B) may include, for example, at least one non-ionic water-soluble polymer selected from among a polyethylene glycol (PEG), polypropylene glycol, a polyethylene polypropylene copolymer, polyglycerin, polyethylene glycol dimethyl ether, hydroxyethylene cellulose, polyvinyl alcohol, stearic acid polyglycol ether, and stearyl alcohol polyglycol ether. However, the type of the moderator is not limited thereto, and other non-ionic water-soluble polymers usable to manufacture the high strength copper foil 110 may be used as the moderator.

The roughness regulator (component C) includes a nitrogen-containing heterocyclic quaternary ammonium salt or a derivative thereof.

The roughness regulator (component C) improves glossiness and evenness of the copper foil 110. The roughness regulator (component C) may have a concentration of 1 to 15 ppm in the electrolyte 20.

When the concentration of the roughness regulator (component C) is less than 1 ppm, the effect of improving the glossiness and evenness of the copper foil 110 may not be exhibited. Accordingly, the first roughness variation exceeds 0.7 μm, and the second roughness variation exceeds 0.8 μm.

On the other hand, when the concentration of the roughness regulator (component C) exceeds 15 ppm, the weight and the surface roughness of the copper foil 110 after immersion may be changed. Accordingly, there is a rapid change in the weight of the copper foil 110 after the immersion, causing the first weight retention rate to exceed 0.1% and the second weight retention rate to exceed 0.3%. In addition, copper is non-uniformly electrodeposited, and thus, the surface of the copper foil 110 becomes irregular, causing the first roughness variation to exceed 0.7 μm and the second roughness variation to exceed 0.8 μm. More specifically, the roughness regulator (component C) may have a concentration of 5 ppm to 10 ppm in the electrolyte 20.

The roughness regulator (component C) may include at least one of compounds represented by Chemical Formulae 1 to 5 below.

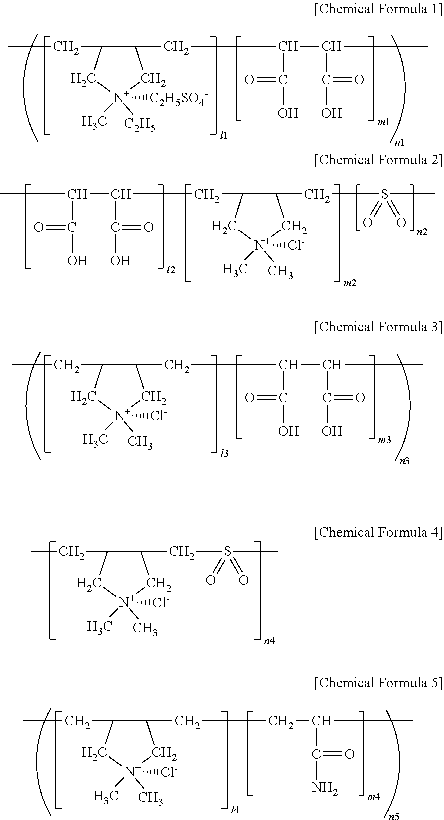

In Chemical Formulae 1 to 5, 11 to 14, m1 to m4, and n1 to n5 may each refer to a repeating unit, may each be an integer greater than or equal to 1, and may be identical to or different from each other.

According to one embodiment of the present disclosure, each of the compounds represented by Chemical Formulae 1 to 5 has a number average molecular weight of 500 to 12,000.

When the number average molecular weight of the compounds represented by Chemical Formulae 1 to 5 and used as the roughness regulator is less than 500, the surface roughness of the copper foil 110 is increased due to a high ratio of monomers. When the content of roughness regulator is low, the surface roughness of the copper film 111 may be increased, and thus the glossiness and evenness of the copper film 111 may be deteriorated.

When the number average molecular weight of the compounds represented by Chemical Formulae 1 to 5 exceeds 12,000, a surface roughness deviation of the copper foil 110 is increased. In this case, although a concentration of other additives is adjusted, it is difficult to suppress an increase in the surface roughness deviation of the copper foil 110.

The compounds represented by Chemical Formulae 1 to 5 may be prepared through polymerization or copolymerization using, for example, diallyl dimethyl ammonium chloride (DDAC).

As the compound represented by Chemical Formula 1, for example, there is PAS-2451 (with Mw 30,000 manufactured by Nittobo Co., Ltd.) or the like.

As the compound represented by Chemical Formula 2, for example, there is PAS-84 (with Mw 20,000 manufactured by Nittobo Co., Ltd.) or the like.

As the compound represented by Chemical Formula 3, for example, there is PAS-2351 (with Mw 25,000 manufactured by Nittobo Co., Ltd.) or the like.

As the compound represented by Chemical Formula 4, for example, there is PAS-A-1 (with Mw 5,000 manufactured by Nittobo Co., Ltd.), PAS-A-5 (with Mw 4,000 manufactured by Nittobo Co., Ltd.), or the like.

As the compound represented by Chemical Formula 5, for example, there is PAS-J-81 (with Mw 180,000 manufactured by Nittobo Co., Ltd.) or the like.

When the copper film 111 is formed, a flow rate of the electrolyte 20 supplied into the electrolytic bath 10 may be 41 m³/hour to 45 m³/hour.

The forming of the copper film 111 may include at least one of filtering the electrolyte 20 using activated carbon, filtering the electrolyte 20 using diatomaceous earth, and treating the electrolyte 20 with ozone (O₃).

Specifically, in order to filter the electrolyte 20, the electrolyte 20 may be circulated at a flow rate of 35 m³/hour to 45 m³/hour. That is, in order to remove solid impurities present in the electrolyte 20 while electroplating to form the copper film 111, filtering may be performed at the flow rate of 35 m³/hour to 45 m³/hour. In this case, activated carbon or diatomaceous earth may be used.

In order to maintain the cleanliness of the electrolyte 20, the electrolyte 20 may be treated with ozone (O₃).

In addition, in order to maintain the cleanliness of the electrolyte 20, a copper (Cu) wire used as a raw material for the electrolyte 20 may be cleaned.

According to one embodiment of the present disclosure, preparing the electrolyte 20 may include heat-treating a Cu wire, acid-cleaning the heat-treated Cu wire, water-cleaning the acid-cleaned Cu wire, and inputting the water-cleaned Cu wire into sulfuric acid for an electrolyte.

More specifically, in order to maintain the cleanliness of the electrolyte 20, a Cu wire with a high purity (99.9% or more) is heat-treated in an electric furnace at a temperature of 750° C. to 850° C. to burn various organic impurities attached to the Cu wire, the heat-treated Cu wire is acid-cleaned using a 10% sulfuric acid solution for 10 to 20 minutes, and the acid-cleaned Cu wire is then water-cleaned using distilled water, thereby preparing copper for manufacturing the electrolyte 20. The water-cleaned Cu wire may be input into sulfuric acid for an electrolyte to prepare the electrolyte 20.

According to one embodiment of the present disclosure, in order to satisfy the characteristics of the copper foil 110, a concentration of TOC in the electrolyte 20 is controlled to be 300 ppm or less. That is, the electrolyte 20 may have a TOC concentration of 300 ppm or less.

The copper film 111 thus prepared may be cleaned in a cleaning bath.

For example, an acid cleaning process for removing impurities on a surface of the copper film 111, for example, resin components or natural oxides, and a water cleaning process for removing acidic solutions used for the acid cleaning may be sequentially performed. The cleaning process may be omitted.

Next, the protective layer 112 is formed on the copper film 111.

Referring to FIG. 6, the method may further include immersing the copper film 111 in an anticorrosion solution 60. When the copper film 111 is immersed in the anticorrosion solution 60, the copper film 111 may be guided by a guide roll disposed in the anticorrosion solution 60.

As described above, the anticorrosion solution 60 may include at least one of a chromium compound, a silane compound, and a nitrogen compound. For example, the copper film 111 may be immersed in a 1 g/L to 10 g/L potassium dichromate solution at room temperature for 1 to 30 seconds.

Meanwhile, the protective layer 112 may include a silane compound by silane treatment or a nitrogen compound by nitrogen treatment.

The copper foil 110 is formed by forming the protective layer 112.

At least one anode active material selected from the group consisting of a carbon, a metal (Me) of Si, Ge, Sn, Li, Zn, Mg, Cd, Ce, Ni or Fe, an alloy including the metal (Me), an oxide (MeOₓ) of the metal (Me), and a composite of the metal (Me) and carbon is coated on one surface or both surfaces the copper foil 110 of the present disclosure prepared through the method as described above to manufacture an electrode (i.e., anode) for a secondary battery of the present disclosure.

For example, 100 parts by weight of carbon for an anode active material, 1 to 3 parts by weight of styrene butadiene rubber (SBR), and 1 to 3 parts by weight of carboxymethyl cellulose (CMC) are mixed and prepared as a slurry using distilled water as a solvent. Subsequently, the slurry is applied on the copper foil 110 to a thickness of 20 μm to 60 μm using a doctor blade and pressed at a pressure of 0.5 to 1.5 ton/cm² at 110° C. to 130° C.

A secondary battery may be manufactured using the electrode (anode) for a secondary battery of the present disclosure manufactured through the method as described above, together with the conventional cathode, electrolyte and separator.

Hereinafter, the present disclosure will be described in detail with reference to examples and comparative examples. However, the examples described below are only intended to aid the understanding of the present disclosure, and the scope of the present disclosure is not limited to these examples.

### Examples 1 to 4 and Comparative Examples 1 to 4

A copper foil was prepared using a foil maker including an electrolytic bath 10, a rotating anode drum 40 disposed in the electrolytic bath 10, and a cathode plate 30 disposed to be spaced apart from the rotating anode drum 40. An electrolyte 20 was a copper sulfate solution. A concentration of copper ions in the electrolyte 20 was set to 87 g/L, a concentration of sulfuric acid was set to 110 g/L, a temperature of the electrolyte was set to 55° C., and a current density was set to 60 ASD.

In addition, a concentration of chlorine (Cl) contained in the electrolyte 20 was maintained at 20 ppm, and concentrations of lead ions, arsenic, silver ions, hydrogen peroxide, and an organic additive were as shown in Table 1 below.

In the organic additive, a bis-(3-sulfopropyl)-disulfide disodium salt (SPS) was used as a polishing agent (component A), PEG was used as a moderator (component B), and a diallylmethylethyl-ammoniumethylsulfate/maleic acid copolymer (PAS-2451™ with Mw 30,000 manufactured by Nittobo Co., Ltd.) was used as a roughness regulator (component C).

A current at a current density of 60 ASD was applied between the rotating anode drum 40 and the cathode plate 30 to prepare a copper film 111. Thereafter, the copper film 111 was immersed in an anticorrosion solution for about two seconds to treat a surface of the copper film 111 with chromium to form a protective layer 112, thereby preparing a copper foil 110. An anticorrosion solution containing chromic acid as a main component was used as the anticorrosion solution, and a concentration of the chromic acid was 5 g/L.

As a result, copper foils of Examples 1 to 4 and Comparative Examples 1 to 4 were prepared.

TABLE 1

| | SPS | PEG | PAS-2451 | Lead | | Silver | |
|---|---|---|---|---|---|---|---|
| | (Component A) | (Component B) | (Component C) | ions | Arsenic | ions | Hydrogen |
| | (ppm) | (ppm) | (ppm) | (ppm) | (ppm) | (ppm) | peroxide |
| Example 1 | 5 | 2 | 5 | 30 | 1.5 | 0.5 | 2 |
| Example 2 | 10 | 4 | 7 | 30 | 1.6 | 0.7 | 5 |
| Example 3 | 15 | 6 | 10 | 50 | 2.5 | 1.3 | 7 |
| Example 4 | 10 | 8 | 12 | 70 | 3.5 | 2.3 | 7 |
| Comparative | 55 | 5 | 10 | 0.1 | 7.0 | 0.7 | 9 |
| Example 1 | | | | | | | |
| Comparative | 10 | 0 | 15 | 50 | 0.1 | 5.5 | 7 |
| Example 2 | | | | | | | |
| Comparative | 15 | 7 | 55 | 150 | 1.5 | 0.7 | 5 |
| Example 3 | | | | | | | |
| Comparative | 10 | 10 | 10 | 150 | 2.5 | 0.8 | 55 |
| Example 4 | | | | | | | |

TABLE 2

| | | | | First | Second | |
|---|---|---|---|---|---|---|
| | Weight (g) | Weight (g) | Weight (g) | weight | weight | Occurrence |
| | before | after 5 hr | after 24 hr | retention | retention | of wrinkle/ |
| | immersion | immersion | immersion | rate (%) | rate (%) | tear |
| Example 1 | 0.1797 | 0.1797 | 0.1796 | 0.000% | 0.056% | no |
| Example 2 | 0.1795 | 0.1795 | 0.1794 | 0.000% | 0.056% | no |
| Example 3 | 0.1796 | 0.1795 | 0.1794 | 0.056% | 0.111% | no |
| Example 4 | 0.1798 | 0.1798 | 0.1797 | 0.000% | 0.056% | no |
| Comparative | 0.1795 | 0.1793 | 0.1790 | 0.111% | 0.279% | Occurance |
| Example 1 | | | | | | |
| Comparative | 0.1799 | 0.1797 | 0.1794 | 0.111% | 0.278% | Occurance |
| Example 2 | | | | | | |
| Comparative | 0.1801 | 0.1798 | 0.1793 | 0.167% | 0.444% | Occurance |
| Example 3 | | | | | | |
| Comparative | 0.1794 | 0.1791 | 0.1787 | 0.167% | 0.390% | Occurance |
| Example 4 | | | | | | |

TABLE 3

| | Surface | Surface | | Surface | Surface | | |
|---|---|---|---|---|---|---|---|
| | roughness | roughness | | roughness | roughness | | |
| | (Rz) of | (Rz) of | | (Rz) of | (Rz) of | | |
| | matte surface | matte surface | First | shiny surface | shiny surface | Second | |
| | before | after 24 hr | roughness | before | after 24 hr | roughness | Occurrence |
| | immersion | immersion | variation | immersion | immersion | variation | of wrinkle/ |
| | (μm) | (μm) | (μm) | (μm) | (μm) | (μm) | tear |
| Example 1 | 0.89 | 1.45 | 0.56 | 1.02 | 1.34 | 0.32 | no |
| Example 2 | 1.28 | 1.78 | 0.50 | 1.18 | 1.33 | 0.15 | no |
| Example 3 | 1.32 | 1.77 | 0.45 | 0.99 | 1.45 | 0.46 | no |
| Example 4 | 1.38 | 1.79 | 0.41 | 1.11 | 1.43 | 0.32 | no |
| Comparative | 1.21 | 2.41 | 1.20 | 1.20 | 2.31 | 1.11 | Occurance |
| Example 1 | | | | | | | |
| Comparative | 1.33 | 2.12 | 0.79 | 1.21 | 2.10 | 0.89 | Occurance |
| Example 2 | | | | | | | |
| Comparative | 1.56 | 2.51 | 0.95 | 1.45 | 2.49 | 1.04 | Occurance |
| Example 3 | | | | | | | |
| Comparative | 1.29 | 2.11 | 0.82 | 1.25 | 2.08 | 0.83 | Occurance |
| Example 4 | | | | | | | |

For the copper foils of Examples 1 to 4 and Comparative Examples 1 to 4 prepared as described above, i) weight before immersion, ii) weight after 5 hr immersion, iii) weight after 24 hr immersion, iv) first weight retention rate, v) second weight retention rate, vi) surface roughness (Rz) of matte surface before immersion, vii) surface roughness (Rz) of shiny surface before immersion, viii) surface roughness (Rz) of matte surface after 24 hr immersion, ix) surface roughness (Rz) of shiny surface after 24 hr immersion, x) first roughness variation, and xi) second roughness variation were measured and calculated, and xii) occurrence of wrinkle/tear was checked.

A sample of the copper foil 110 was cut into 5 mm*5 mm, dried in an oven at 50° C. for 24 hours, and then subjected to a pre-treatment process for cooling the sample in a desiccator.

### i) Measurement of Weight Before Immersion

The weight of the copper foil 110 before immersion refers to a weight of the sample measured before immersing the sample in a 20% NaOH solution.

ii) Measurement of Weight after 5 hr Immersion

The weight of the copper foil 110 after 5 hr immersion refers to a weight of the sample measured after immersing the sample in a 20% NaOH solution for 5 hours.

The immersion is performed in a 20% NaOH solution for 5 hours, and the weight of the sample is measured after drying at room temperature for 2 hours after the immersion.

iii) Measurement of Weight after 24 hr Immersion

The weight of the copper foil 110 after 24 hr immersion refers to a weight of the sample measured after immersing the sample in a 20% NaOH solution for 24 hours.

The immersion is performed in a 20% NaOH solution for 24 hours, and the weight of the sample is measured after drying at room temperature for 2 hours after the immersion.

Calculation of iv) first weight retention rate and v) second weight retention rate

The first weight retention rate may be obtained through a calculation according to Equation 1 below using values of the measured i) weight before immersion and ii) weight after 5 hr immersion.

$$First weight retention rate = \vert ( weight after 5 hr immersion - weight before immersion ) / weight before immersion * 100 \vert \qquad [ Equation 1 ]$$

The second weight retention rate may be obtained through a calculation according to Equation 2 below using values of the measured i) weight before immersion and iii) weight after 24 hr immersion.

$$Second weight retention rate = \vert ( weight after 24 hr immersion - weight before immersion ) / weight before immersion * 100 \vert \qquad [ Equation 2 ]$$

Measurement of vi) surface roughness (Rz) of matte surface before immersion and vii) surface roughness (Rz) of shiny surface before immersion

The surface roughness (Rz) of a matte surface before immersion and a surface roughness (Rz) of a shiny surface before immersion refer to ten-point average roughnesses (Rz) of the matte surface (M surface) and the shiny surface (S surface) of the copper foil 110, respectively, before immersion.

The surface roughness (Rz) of the matte surface before immersion and the surface roughness (Rz) of the shiny surface before immersion may each be measured from the sample of 5 mm*5 mm by using a surface roughness measurement device (M300, MahrSurf) in accordance with specifications of JIS B 0601-1994.

Measurement of viii) surface roughness (Rz) of matte surface and ix) surface roughness (Rz) of shiny surface, after 24 hr immersion

The surface roughness (Rz) of the matte surface after 24 hr immersion refers to a ten-point average roughness (Rz) of the matte surface (M surface) of the copper foil 110 after immersing the copper foil 110 in a 20% NaOH solution for 24 hours, and the surface roughness (Rz) of the shiny surface after 24 hr immersion refers to a ten-point average roughness (Rz) of the shiny surface (S surface) of the copper foil 110 after immersing the copper foil 110 in a 20% NaOH solution for 24 hours.

The immersion used for measuring the surface roughness (Rz) is the same as an immersion process used for the measurement of iii) weight after 24 hr immersion. The sample is dried at room temperature for 2 hours after the immersion, and then the surface roughness is measured in the same manner as vi) surface roughness (Rz) of matte surface before immersion and vii) surface roughness (Rz) of shiny surface before immersion.

Calculation of x) first roughness variation and xi) second roughness variation

The first roughness variation may be obtained through a calculation according to Equation 3 below using values of the measured vi) surface roughness (Rz) of matte surface before immersion and Viii) surface roughness (Rz) of matte surface after 24 hr immersion.

$$First roughness variation = \vert surface roughness ( Rz ) of matte surface after 24 hr immersion - surface roughness ( Rz ) of matte surface before immersion \vert \qquad [ Equation 3 ]$$

The second roughness variation may be obtained through a calculation according to Equation 4 below using values of the measured vii) surface roughness (Rz) of shiny surface before immersion and ix) surface roughness (Rz) of shiny surface after 24 hr immersion.

$$Second roughness variation = \vert surface roughness ( Rz ) of shiny surface after 24 hr immersion - surface roughness ( Rz ) of shiny surface before immersion ) \qquad [ Equation 4 ]$$

xii) Occurrence of Wrinkle/Tear

After 100 charge and discharge cycles, the secondary battery was disassembled to observe whether a wrinkle or a tear occurred on the copper foil. When the copper foil was wrinkled or torn, the copper foil was labeled as “occurrence,” and when the copper foil was not wrinkled or torn, the copper foil was labeled as “no.”

Referring to Tables 1, 2, and 3, the following results may be confirmed.

A tear/wrinkle occurred in the copper foil of Comparative Example 1 prepared using an electrolyte including the polishing agent (component A) and the arsenic in an excessive amount, and the lead ions in a small amount.

A tear/wrinkle occurred in the copper foil of Comparative Example 2 prepared using an electrolyte including a moderator (component B) and arsenic in small amounts, and silver ions in an excessive amount.

A tear/wrinkle occurred in the copper foil of Comparative Example 3 prepared using an electrolyte including a roughness regulator (component C) and lead ions in excessive amounts.

A tear/wrinkle occurred in the copper foil of Comparative Example 4 prepared using an electrolyte including lead ions and hydrogen peroxide in excessive amounts.

On the other hand, all the copper foils of Examples 1 to 4 according to the present disclosure satisfied values within the above standard ranges, and as a result, no tears/wrinkles occurred in the copper foil.

According to the present disclosure, the occurrence of wrinkles or tears can be prevented in a manufacturing process of a copper foil, and even after immersion, a surface state of the copper foil can be maintained and the occurrence of wrinkles or tears can be prevented and controlled. In addition, intermediate parts, such as flexible printed circuit boards (FPCBs) and secondary batteries, and final products can be manufactured using the copper foil, so that productivity of the intermediate parts as well as the final products can be improved.

It will be apparent to those skilled in the art that the present disclosure described above is not limited by the above-described embodiments and the accompanying drawings and that various substitutions, modifications, and variations can be made in the present disclosure without departing from the spirit and scope of the present disclosure. Accordingly, the scope of the present disclosure is defined by the accompanying claims, and it is intended that all variations and modifications derived from the meaning, scope, and equivalent concept of the claims fall within the scope of the present disclosure.

### DESCRIPTION OF REFERENCE NUMERALS

100: electrode for second battery
110: copper foil
111: copper film
120: active material layer
10: electrolytic bath
20: electrolyte

What is claimed is:

1. A copper foil comprising a copper film including 99.9 wt % or more of copper,
wherein the copper foil has a first weight retention rate of 0.1% or less, and a second weight retention rate of 0.3% or less,
wherein the first weight retention rate is calculated by Equation 1 below,
$$first weight retention rate = \vert ( weight after 5 hr immersion - weight before immersion ) / weight before immersion * 100 \vert , and \qquad [ Equation 1 ]$$
$$the second weight retention rate is calculated by Equation 2 below ,$$
$$s econd weight retention rate = \vert ( weight after 24 hr immersion - weight before immersion ) / weight before immersion * 100 \vert . \qquad [ Equation 2 ]$$

2. The copper foil of claim 1, wherein the copper film includes a matte surface and a shiny surface, and has a first roughness variation of 0.7 μm or less,
wherein the first roughness variation is calculated by Equation 3 below,
$$first roughness variation = \vert surface roughness ( Rz ) of matte surface after 24 hr immersion - surface roughness ( Rz ) of matte surface before immersion \vert . \qquad [ Equation 3 ]$$

3. The copper foil of claim 1, wherein the copper film includes a matte surface and a shiny surface, and has a second roughness variation of 0.8 μm or less,
wherein the second roughness variation is calculated by Equation 4 below,
$$second roughness variation = \vert surface roughness ( Rz ) of shiny surface after 24 hr immersion - surface roughness ( Rz ) of shiny surface before immersion ) . \qquad [ Equation 4 ]$$

4. The copper foil of claim 1, further comprising a protective layer formed on the copper film.

5. The copper foil of claim 4, wherein the protective layer includes at least one of a chromium compound, a silane compound, and a nitrogen compound.
